(19) United States
(12) Patent Application Publication
(10) Pub. No.: US 2014/0201216 A1
(43) Pub. Date: Jul. 17, 2014

(54) CREATING USER SKILL PROFILES THROUGH USE OF AN ENTERPRISE SOCIAL NETWORK

(71) Applicant: HEWLETT-PACKARD DEVELOPMENT COMPANY, L.P., (US)

(72) Inventors: Andrew Bryant, Grenoble Isere (FR); Christopher Kirby, Herndon, VA (US); Claudio Bartolini, Palo Alto, CA (US)

(73) Assignee: HEWLETT-PACKARD DEVELOPMENT COMPANY, L.P., Fort Collines, CO (US)

(21) Appl. No.: 13/742,093

(22) Filed: Jan. 15, 2013

(51) Int. Cl. G06F 17/30

(52) U.S. Cl. CPC G06F 17/30386
USPC 707/748

(57) ABSTRACT

Systems and methods to generate user skill profiles through use of an enterprise social network are disclosed. An example method may include linking hash tags and people tags with access to at least one topic-based discussion space in the enterprise social network. The method may also include assigning a topic authority score to a user in the enterprise social network. The method may also include matching the user to a skill profile based on the topic authority score of the user.

### BACKGROUND

Human resources (HR) systems capture employee information, which may be used for promotions, inter-departmental transfers, and project assignment, among other uses. However, encouraging employees to update their information using the human resources systems is a task employers may only undertake on a semi-regular (e.g., annual or semi-annual) basis. As such, much of the information may be out-of-date for much of the year.

In addition, HR systems can be complex to use. The taxonomies used in typical human resources systems often include categories that do not apply to employees across all departments. For example, an employee in the engineering department may have to search through categories that are only relevant to employees in the accounting department, or to employees in the marketing department.

Employees often consider having to update their information in the HR system as “just one more thing to do,” with little apparent incentive or immediate reward for the employee, thus resulting in a less than complete skill profile for each employee. In turn, the HR system provides little, if any value to the employer.

### BRIEF DESCRIPTION OF THE DRAWINGS

FIG. 1 is a high-level illustration of an example networked computer system which may be implemented to find user skill profiles through an enterprise social network.

FIG. 2 shows an example architecture of machine readable instructions, which may be executed to find user skill profiles through an enterprise social network.

FIGS. 3a-c show example interfaces, which may be used to find user skill profiles through an enterprise social network.

FIGS. 4a-c are flowcharts illustrating example operations which may be implemented to find user skill profiles through an enterprise social network.

### DETAILED DESCRIPTION

Access to employee information may be restricted within an organization to only HR professionals. But staffing in corporate human resources (HR) departments has been reduced in recent years, such that a proactive search of employee information is a low priority to overworked HR professionals. As such, proactive searches for employee skill sets are rarely used, except for perhaps at the senior executive level.

Employee information may be useful to other employees in an organization (e.g., project managers and supervisors) to discover expertise that may exist within the organization. The systems and methods described herein enable members of an organization (e.g., employees) to seamlessly develop their skill profiles in such a manner that they do not even realize that they are doing it. The skill profile enables other members of the organization to search across the organization and discover those members within the organization having skills (or interests) that may be a good fit for a particular position or project, or who may have an answer to a question or a solution to a problem. Other uses of the skill profile will also become apparent to those having ordinary skill in the art after understanding the teachings herein.

Systems and methods are described herein which may be implemented to find user skill profiles through the use and analysis of meta-data associated with or generated by a user including hash-tags (#tags), people-tags, and discussion threads in an enterprise social network (ESN). In an example, topic based discussion spaces (e.g., public rooms and/or private rooms) may be created. The discussion-threads in these “rooms” combine to form conversations which result in a persistent and traceable archive of various topics, each identified by the user through the dynamic creation of hash-tags. Users insert meaningful hash-tags associated with certain topics into conversations frequently in order to link and aggregate discussions on that topic. The system automatically turns the #tags created by the user into a search for other threads that utilize that #tag. User skill profiles may then be generated by linking the corresponding hash-tags (#tags) from these conversations to an employee's profile, thus turning the act of aggregating and maintaining employee information from an irregular chore, into a natural byproduct of social discussion in the ESN. The information in the user skill profiles can be used by any other employees and human resources staff to identify topic “experts” within the organization.

Before continuing, it is noted that as used herein, the terms “includes” and “including” mean, but are not limited to, “includes” or “including” and “includes at least” or “including at least.” The term “based on” means “based on” and “based at least in part on.”

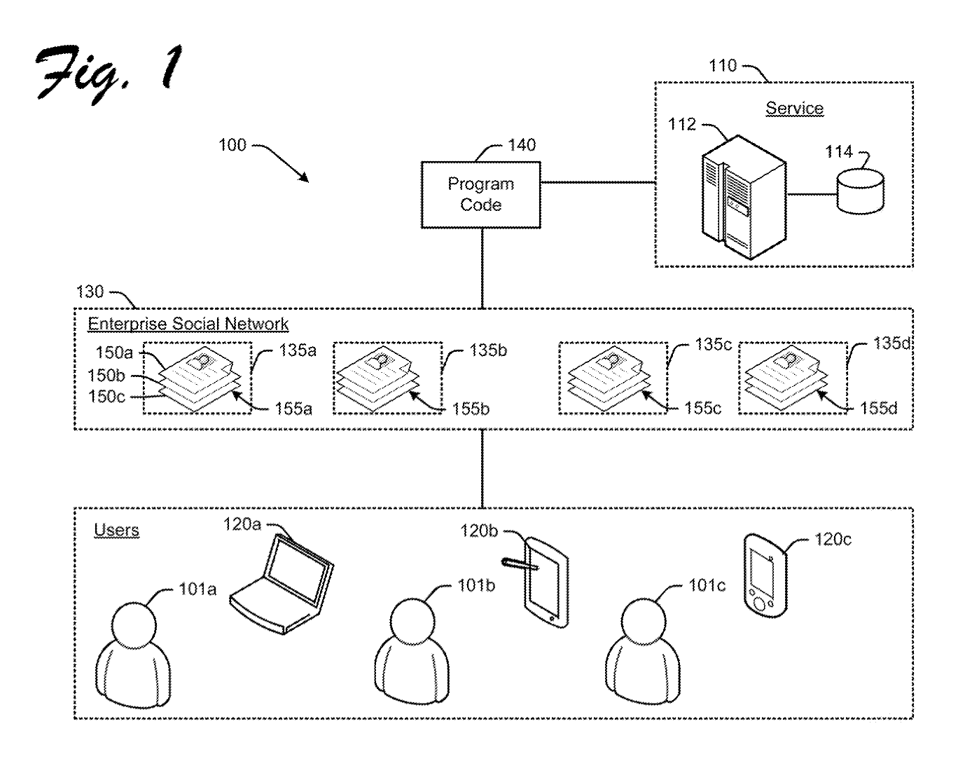

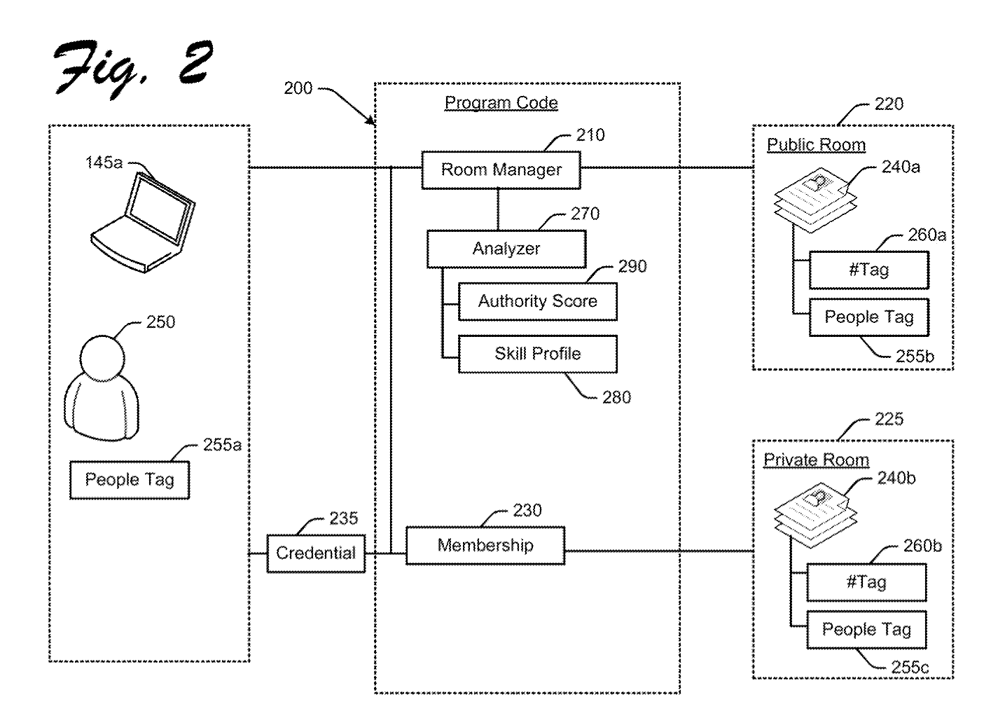

FIG. 1 is a high-level block diagram of an example networked computer system which may be implemented to find user skill profiles through an enterprise social network, System 100 may be implemented with any of a wide variety of computing devices, such as, but not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 100 may include a host 110 providing a service accessed by users 101a-c via respective client devices 120a-c. For purposes of illustration, the service may be an online ESN 130 executing on the host 110 configured as a server computer 112 with computer-readable storage 114. The service may be instantiated via program code 140 and associated application programming interfaces (APIs) and support infrastructure, as is commonly used in social media networks (e.g., Internet-based and/or corporate intranet-based social networks). The service enables users to post discussion threads 150a-c to topic-specific or general discussion spaces (virtual rooms or “rooms” for short) 135a-c in the ESN 130, thereby forming “conversations” 155a-d on a variety of topics.

The ESN 130 provides capabilities for “tagging” users with skills via user-defined tags corresponding to the issue being discussed. The systems and methods described herein further define both hash tags and people tags, and introduce the concept of both public and private discussion groups in combination with these hash tags and people tags. Tags provide an up-to-date technique for automatically finding user skill profiles in the ESN 130. The tags are always recent and relevant, based on the subject that the user is currently discussing or working on, because people tags are assigned during the process of joining a room, and hash tags are assigned when a user uses them in a conversation.

Hash tags (or #tag) may be created by the user by typing the hash symbol (#), followed by a word or sequence of words, delimited by a space. When posted to the service, another user can select (or “click on”) the hash tag, which generally results in the user being taken to a search page that returns all of the instances where the hash tag has been used. A dynamic search may also be used. For example, relevant hash tags may be “suggested” as the user starts to type a hash tag, making it easy for the user to find existing hash tags. This may help reduce or eliminate the creation of parallel tags (different hash tag for the same topic) when posting discussion threads. Hash tags are hence both easy to create, and informative, and discussion threads can readily follow ‘themes’ identified by a hash tag without unnecessarily cluttering the ESN 130 with a multitude of hash tags.

People-tags can be created similar to hash tags, but people tags are assigned to a user and denote skills, interests, projects, or any of a variety of characteristics the user would like to use to identify himself or herself. People-tags are typically assigned to the user manually by the user, although people tags may also be assigned to a user by another user. The systems and methods described herein use people tags as a membership indication in the rooms 135a-d.

Rooms 135a-d may be created in the ESN 130 by the users. For example, the user may start a new room 135a-d by assigning a topic and one or more relevant hash tags for the room 135a-d. Rooms 135a-d may also be created in the ESN 130 automatically by the program code 140, For example, the first time a user types a hash tag, a room 135a-d corresponding to the topic may be created in the ESN 130. After creating a room 135a-d, other discussion threads including the same hash tag may be populated into the room.

Other users may discover rooms 135a-d through mentions of the hash tag, e.g., on a main “public” micro-blog stream, through topic searches, and/or tag-cloud listings. Other users can “click to enter” the room and view conversations 155a-d. In an example, however, users are unable to post discussion threads 150a-c in a room 135a-d until the user joins the room 135a-d. Joining a room 135a-d can be accomplished by applying a people tag to the user's profile (e.g., with a single mouse click).

It is noted that some rooms 135a-d may only be accessed if a user has permission to join the room 135a-d and/or to post a discussion thread 150a-c in the room 135a-d. In an example, access to the room 135a-d may be restricted based on people tags. That is, in order to enter the room 135a-d, a user may need to have a particular people tag. In order to earn the requisite people tag, the user may need to perform a prerequisite action. In another example, access to the rooms 135a-d may be restricted based on a “secret” code. In order to be granted the secret code, the user may need to perform a prerequisite action. Examples of prerequisite actions include, but are not limited to, taking a course, visiting a physical room, and watching a presentation. The people tag and/or secret may be provided after satisfying the prerequisite, for example, via a uniform resource locator (URL) which is encoded in a barcode such as a quick response (QR) code, provided to a mobile device by a RFID tag in the physical location, or through the action of ‘checking-in’ to the physical location on a location-based network.

A user's topic-based skill-sets may be ranked by their peers, for example, based on the user's contribution to conversations 155a-d. In an example, the systems and methods may assign authority scores to the users.

For example, the more “likes” a user's discussion threads that use a specific #tag 150a-c receives from other users, the more it contributes to the user's topic authority score for that #tag. A list of the top ranked users in the room may be displayed in the room, or his authority on the subject may associated with the user's avatar. In this way, other users visiting a room can readily identify topic experts in the room. In addition, organizations can identify experts on specific subjects using a people-tag list.

The people tags and hash tags in discussion threads 150a-c form a persistent and traceable archive of a user's conversations on various topics. This enables future analysis using both structured meta-data for the room and unstructured text analysis of the contents.

The systems and methods may analyze the hash tags and people tags to find skill profiles (i.e.: people in the organization having particular skills). The skill profiles may be accessible to other users (e.g., everyone within the enterprise), making it easy to identify experts across the business organizations within the enterprise. For example, employees can use the skill profiles to connect with their peers around common interests. HR personnel can use the skill profiles to identify top or scarce talent. In short, the skill profiles may be used to enhance internal career mobility and task assignment.

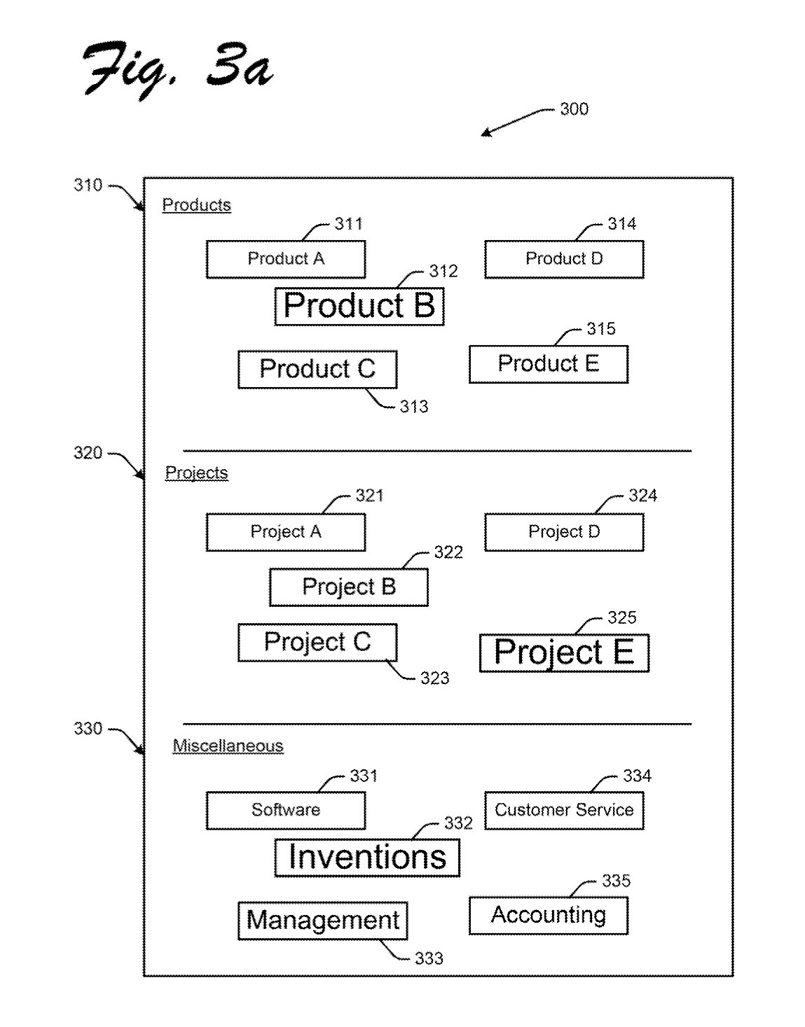

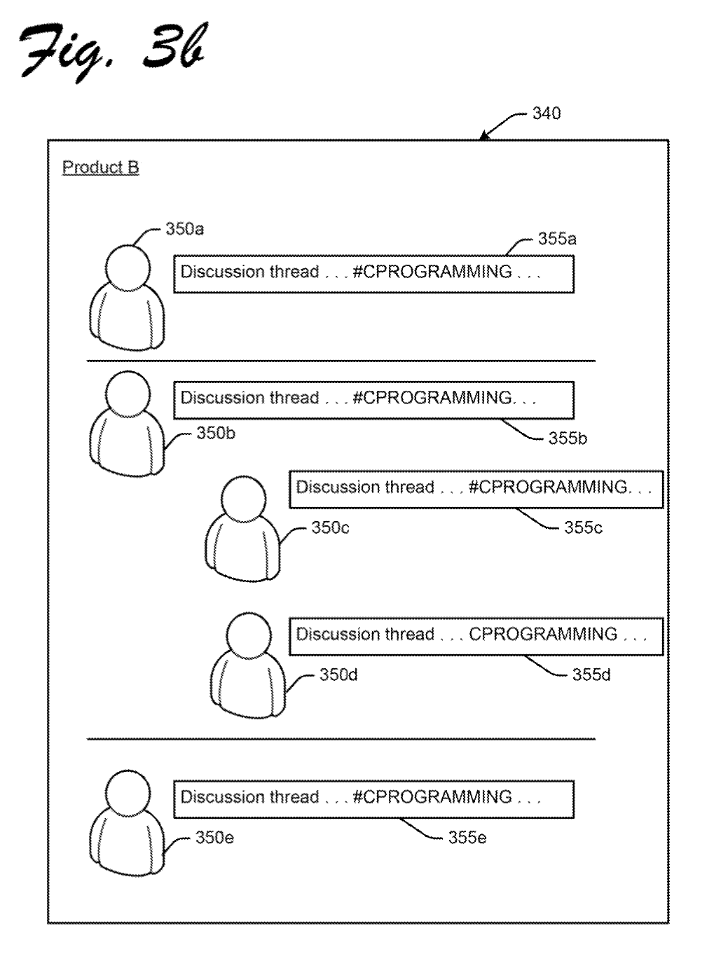

Program code used to implement features of the system can be better understood with reference to FIG. 2 and the following discussion of various example functions. However, the operations described herein are not limited to any specific implementation with any particular type of program code.

FIG. 2 shows an example architecture 200 of machine readable instructions, which may be executed to find user skill profiles through an enterprise social network. In an example, the program code discussed above with reference to FIG. 1 may be implemented in machine-readable instructions (such as but not limited to software or firmware). The machine-readable instructions may be stored on a non-transient computer readable medium and are executable by one or more processor to perform the operations described herein. It is noted, however, that the components shown in FIG. 2 are provided only for purposes of illustration of an example operating environment, and are not intended to limit implementation to any particular system.

The program code executes the function of the architecture of machine readable instructions as self-contained modules. These modules can be integrated within a self-standing tool, or may be implemented as agents that run on top of an existing program code. In an example, the architecture of machine readable instructions may include a room manager 210. The room manager 210 is implemented to create topic-based discussion space or rooms (e.g., public rooms 220 and private rooms 225). The room manager may also function in conjunction with a membership module 230 to control access to the private rooms 225.

In an example, a user may access rooms 220, 225 via an interface displayed in a network browser (e.g., by scrolling through a list of topics and then clicking on the desired subtopic), if the user is requesting access to private room 225, the membership module 230 may only grant access after the user is able to supply the proper credential 235. The user 250 has to have at least one people tag 255 for membership in the virtual room 220 or 225.

The user may enter the virtual room 220 or 225 and post a new discussion thread and/or post to an already existing discussion thread (e.g., by commenting). The discussion threads collectively form a conversation 240a and 240b. Discussion threads may be added to the topic-based discussion space directly by the user 250, and the user 250 may include hash tags 260a and 260b (e.g., #C-Programming) in the discussion thread.

It is noted that the room manager 210 may automatically add discussion threads to the rooms 220 and 225. For example, the room manager 210 may search other rooms and identify discussion thread(s), or even entire conversations, in the other rooms that are relevant to another room. The room manager 210 may automatically “drop” these related discussion threads and/or conversations into particular rooms based on the hash tags.

A sorting engine 270 may be operatively associated with the room manager 210. The people tags and hash tags may be analyzed from discussion threads in any of the topic-based discussions spaces (e.g., public and/or private virtual rooms). The sorting engine links the hash tags 260a-b and people tags 260a-b appearing in conversation(s) 240a-b to find user skill profiles 280. The user skill profiles 280 may be generated based on any of a variety of criteria.

The sorting engine 270 may also assign a topic authority score 290. The topic authority score 290 may be assigned based on any suitable criteria. For example, the topic authority score 290 may be assigned at least in part on the user's participation, membership in private rooms, and/or other user input or corroboration. The topic authority score 290 may help identify those users more likely to possess a skill set.

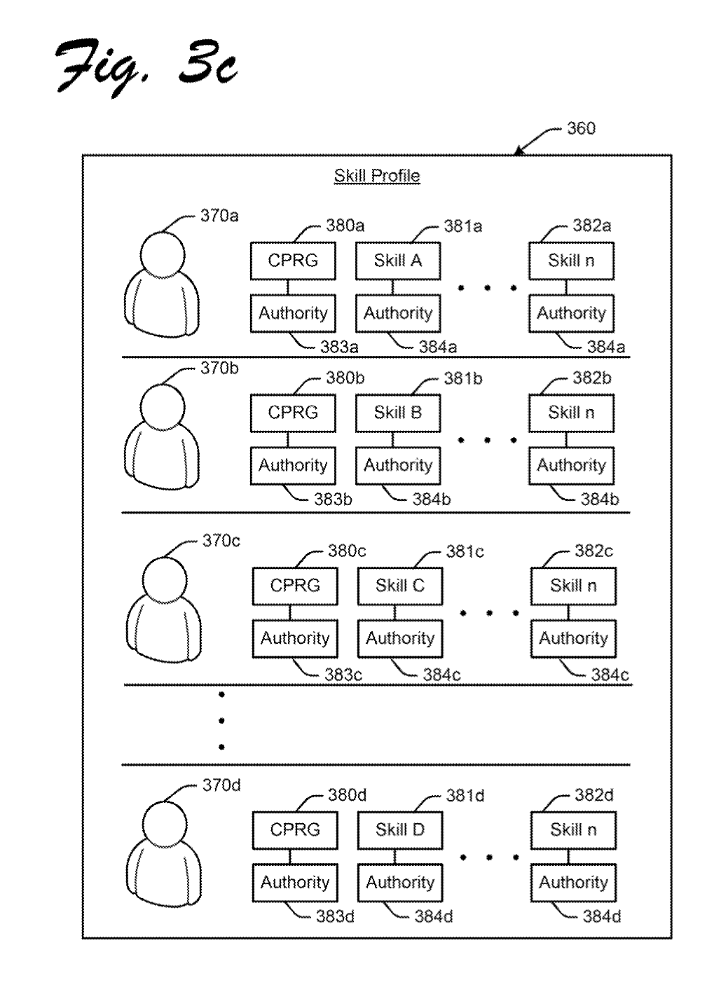

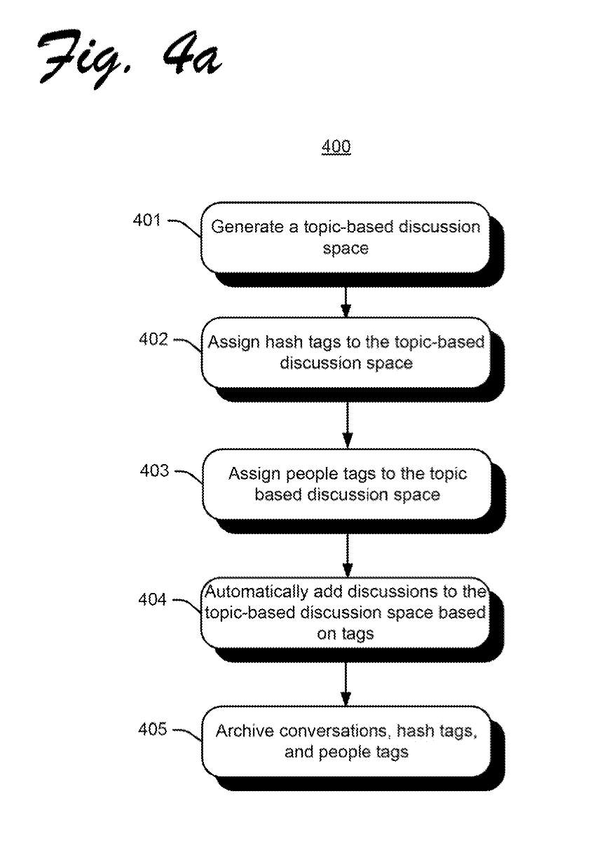

Operation of the program code is illustrated below with reference to example interfaces shown in FIGS. 3a-c which may be generated by the program code.

FIGS. 3a-c show example interfaces, which may be used to find user skill profiles through an enterprise social network. Although the interface may be implemented in any suitable environment, an example of a typical interface is a network browser.

FIG. 3a shows an example interface 300 with links to various topic-based discussion spaces or rooms in the enterprise social network. The rooms may be sorted according to topic and subtopic, or volume and recent activity. In this illustration, topics include discussions for Products 310, Projects 320, and Miscellaneous 330. Subtopics are shown including for Products 310: Product A 311, Product B 312, Product C 313, Product D 314, and Product E 315; for Projects 320: Project A 321, Project B 322, Project C 323, Project D 324, and Project E 325; and for Miscellaneous 330: Software 331, Inventions 332, Management 333, Customer Service 334, and Accounting 335. Subtopics may be highlighted, for example, by color, shape, or text size. For example, a subtopic displayed in a smaller font size may indicate fewer conversations (and/or users) and larger font size may indicate more conversations (and/or users). To illustrate, Product B 312 is shown having a larger font size than Product A 311, indicating that the virtual room for Product B 312 has more conversations (and/or users) than the virtual room for Product A 311. In another example, color may be utilized to identify ‘freshness’ of discussions for instance with dark text indicating the most recent conversations and light text indicating rooms with no recent updates.

A user may access a topic-based discussion space via interface 300, for example, by scrolling through the list of topics and then clicking on a link for a desired subtopic. Of course, the interface 300 shown in FIG. 3a is only intended as an example and other interfaces for displaying and providing access to topic-based discussion space are also contemplated.

FIG. 3b shows an example interface 340 displaying content in a topic-based discussion space or room. For purposes of this illustration, the user entered the room for Product B by selecting the link to Product B 312 in FIG. 3a.

Content in the room may include avatars 350a-e corresponding to users who have posted discussion threads 355a-e. The discussion threads 355a-e collectively form a conversation related to the subtopic Product B. For purposes of illustration, Product B relates to C-programming, as indicated by the hash tag #C-PROGRAMMING appearing in each of the discussion threads 355a-e. In an example, when an association is made between a #tag and a room, and a user is in discussions within that room, the #tag is implied, and may be omitted from messages.

Discussion threads 355a-e may be posted directly by the user, and the user may include hash tags in the discussion. Discussion threads 355a-e may also be added to the room automatically when the program code described herein identifies discussion thread(s), or even entire conversations that are relevant to the topic of the room, even if those discussion threads 355a-e appear in other room(s), or in a public discussion room. That is, the program code may search other virtual rooms and automatically “drop” related conversations into the current room.

By way of illustration, discussion threads 355a-d may have been added to the room for Product B directly by the users 350a-d in the room. The discussion thread 355e may be added automatically to the room for Product B by the program code after locating the discussion thread 355e in another room, by identifying common hash tags (#C-PROGRAMMING in this example).

Likewise, users can be invited to for suggested to post in) new rooms based on their existing people tag(s) or the #tags they have used in discussion threads. In an example, each user writing the discussion threads 355a-e has at least one people tag. The hash tags and people tags appearing in conversation(s) may be assigned to the corresponding topic-based discussion space for use in matching users with skill profiles.

FIG. 3C shows an example interface 360 displaying a set of related skill profiles for individual users (370a-d), each with at least a people tag of C-Programming (380a-d), amongst other tags. The operations described herein link people tags 380a, 381a, 382a that have been assigned to user 370a manually, algorithmically or through the user's use of the corresponding hash tag in discussions. People tags 380a, 381a, 382a are also used as membership indications for each room. The hash tags may be analyzed from discussion threads in any of the discussions spaces (e.g., public and/or private virtual rooms), and used to assign the corresponding people tags (380a, 381a, etc) based on any of a variety of criteria. An example criterion may be that a user has used the hash tag more than a set number of times, and received at least one ‘like’ from another user for that tagged message.

Continuing with the illustration of FIGS. 3a and 3b, the hash tag #C-PROGRAMMING relates to Product B, and users 370a-d each participated in discussions using the hash tag #C-PROGRAMMING in any room; or in a room titled C-PROGRAMMING. Accordingly, the skill profile 360 may be populated with users 370a-d each having at least one people tag C-PROGRAMMING. The users may have other skill sets (e.g., indicated by people tags 381a-d and 382a-d). These other skill sets may for may not) be included in the skill profile 360.

Each user may also be assigned a topic authority score 383a-d for the people tags 380a-d. Topic authority scores 384a-d and 385a-d are shown in the skill profile 360 corresponding to people tags 381a-d and 382a-d, respectively. The topic authority score 383a-d may be assigned based on any suitable criteria. For example, the topic authority score 383a-d may be assigned at least in part on the user's participation, membership in private rooms, frequency of use of the #tag and/or other user input or corroboration such as Likes received from other users, on in rooms associated with the #tag, or on messages using the #tag. Although not intended to be limiting, the topic authority score 383a-d may be a number between 1 and 10 (or any suitable range), wherein users having a higher topic authority score are deemed to be more likely to possess a skill set associated with the hash tag(s). Topic authorities may be shown in the relevant private room (as a list of top users, or associated with a user's avatar) to help new members quickly identify those participants with higher authorities.

The skill profile may be used to identify a user (or users) in the enterprise social network having a desired skill set. The skill profile may be generated by human resources professionals. However, the systems and methods described herein are not limited to any particular user, and the skill profile may be generated by any user and for any user, or shown on the user's personal profile page on the system. For example, the skill profile may be implemented by a supervisor for employee evaluation/promotion, a project manager looking for team members for a particular project, an employee in search of an answer to a question or a solution to a problem, among other uses.

Before continuing, it should be noted that the examples described above are provided for purposes of illustration, and are not intended to be limiting. Other devices and/or device configurations may be utilized to carry out the operations described herein.

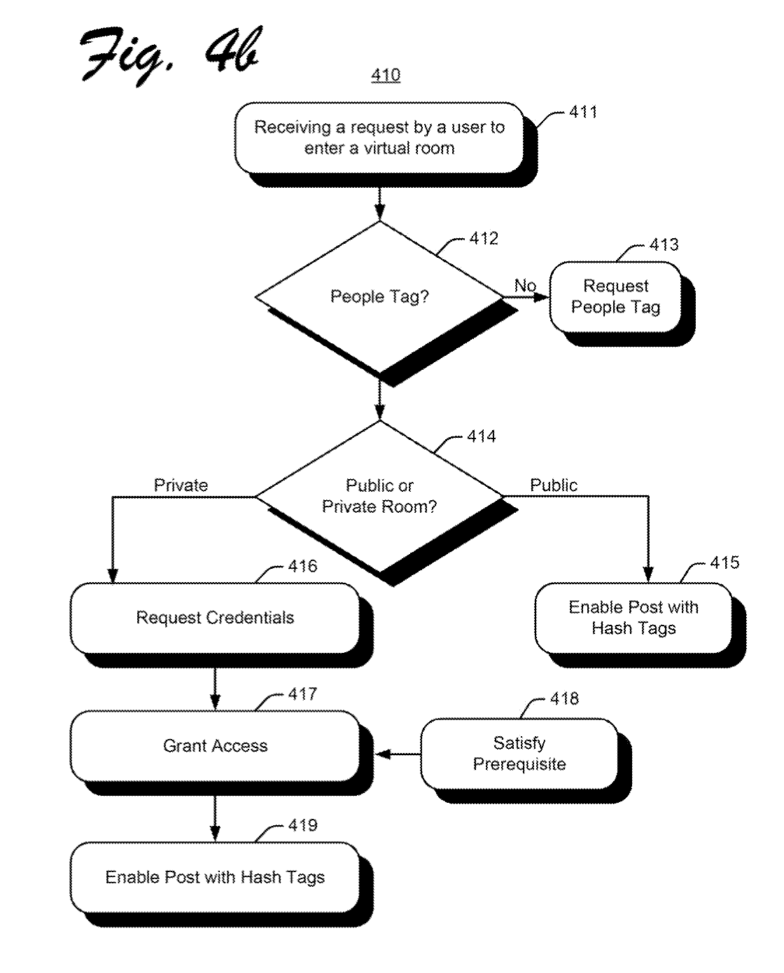

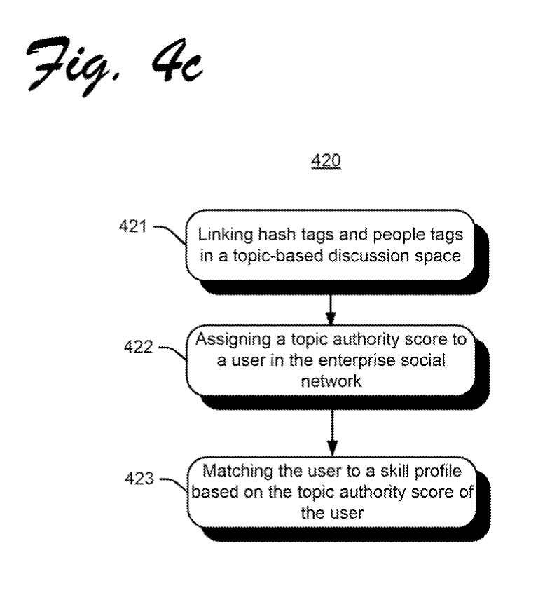

FIGS. 4a-c are flowcharts illustrating example operations which may be implemented to find user skill profiles through an enterprise social network. The operations may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

FIG. 4a illustrates operations 400 to manage topic-based discussion spaces (or rooms). Operation 401 includes generating a topic-based discussion space. In an example, the topic-based discussion space may be generated by a user, such as someone desiring to discuss a particular topic. The topic-based discussion space may also be generated automatically by the program code. For example, the program code may generate a topic-based discussion space after a predetermined number of hash tags appear in conversation(s).

Operation 402 includes assigning hash tags to the topic-based discussion space. Operation 403 includes assigning people tags to the topic-based discussion space. For example, discussion thread(s) (or even entire conversations) may be assigned to the corresponding topic-based discussion space based on the associated hash tags and/or people tags.

Operation 404 includes automatically adding discussions to the topic-based discussion space based on hash tags and/or people tags. For example, the program code may identify other relevant conversations appearing in other virtual rooms based on the hash tags and/or people tags, and automatically “drop” those conversations into the topic-based discussion space.

Operation 405 includes archiving conversations, hash tags, and people tags. As such, the topic-based discussion space becomes a traceable archive that can be used for find user skill profiles through an enterprise social network.

FIG. 4b illustrates operations 410 to manage topic-based discussion spaces (or rooms). Operation 411 includes receiving a request by a user to enter a topic-based discussions space. In operation 412, a determination is made to confirm that the user has a corresponding people tag. If the user does not have a people tag, then the program code may request that the user accept the assignment of the associated people tag to himself or herself in operation 413 before being granted access to the virtual room.

In operation 414, a determination is made whether the topic-based discussions space is a public room or a private room. If the user is requesting to enter a public room, then the user is granted access, Access may include viewing conversations in the public room. In operation 415, posting with hash tags is also enabled.

If the user is requesting to enter a private room, operation 416 includes requesting credentials from the user. The user is only granted access to the private room in operation 417 after the user's credentials have been confirmed. In an example, the user may only be granted credentials after satisfying a prerequisite in operation 418. The prerequisite may include, but is not limited to the user taking a physical action. For example, the user may have to complete a course related to the topic being discussed in the private room, visit a physical room where an administrator can verify the user's credential, and/or watch a presentation.

Access to the private room may include viewing conversations. In operation 419, posting with hash tags may also be enabled, View (or read) and/or post (or write) permissions may be restricted in the private room based on the user's credentials. For example, the user's people tag may indicate that the user has read-only access.

The public and/or private rooms may be monitored to ensure that posts are relevant to the topic being discussed. Irrelevant posts (e.g., off-topic posts) may be removed from the conversation, or moved to a more appropriate room.

FIG. 4c illustrates operations 420 to find user skill profiles through an enterprise social network. Operation 421 includes linking hash tags and people tags in at least one topic-based discussion space in the enterprise social network. Hash tags indicate relevance to a particular topic. People tags are membership indications for the topic-based discussion space.

In an example, hash tags may be connected to people tags based on logical linkages, either created algorithmically or through manual intervention. For example, hash tags #C-Programming from posts are linked to the people tag C-PROGRAMMING.

Operation 422 includes assigning a topic authority score to a user in the enterprise social network. In an example, the topic authority score is assigned based at least in part on the user's participation, membership in private rooms, and/or other user input or corroboration. Operation 423 includes matching the user to a skill profile based on the topic authority score of the user.

The operations shown and described herein are provided to illustrate example implementations. It is noted that the operations are not limited to the ordering shown. Still other operations may also be implemented.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided to purposes of illustration and are not intended to be limiting. Still other examples are also contemplated.

1. A method to automatically generate user skill profiles through of an enterprise social network, comprising:
linking hash tags in conversations on an enterprise social network, and people tags to user profiles in the enterprise social network;
assigning a topic authority score to a user in the enterprise social network; and
matching the user of a skill profile based on the topic authority score of the user.

2. The method of claim 1, further comprising:
dynamically creating a topic-based discussion room based on the hash tags; and
associating the hash tag and people tags (for a topic) with the topic-based discussion room.

3. The method of claim 1, further comprising using the people tags as a membership indication for a topic-based discussion space.

4. The method of claim 1, further comprising requiring the user to join a topic-based discussion space before posting to the topic-based discussion space.

5. The method of claim 4, wherein joining the topic-based discussion space is by applying a tag to a profile of the user.

6. The method of claim 1, further comprising protecting a topic-based discussion space in the enterprise social network with a secret code.

7. The method of claim 6, wherein the user receives the secret code only after meeting a prerequisite condition.

8. The method of claim 6, wherein the user receives the secret code only after at least one of completing a course, evidencing a visit to a physical room, and watching a presentation.

9. A system having computer-readable instructions stored on a non-transient computer-readable medium, the computer-readable instructions executable by a processor to find users with desired skills through an enterprise social network by:
linking hash tags and people tags in at least one topic-based discussion space in the enterprise social network;
assigning a topic authority score based on user interaction in the enterprise social network; and
generating a skill profile based on the topic authority score of the user.

10. The system of claim 9, wherein the topic-based discussion space is protected to restrict user participation.

11. The system of claim 9, wherein the people tags are membership indications for the topic-based discussion space.

12. The system of claim 9, wherein only users having a people tag are permitted to post to a room in the enterprise social network.

13. The system of claim 9, wherein only users having a people tag corresponding to a topic discussed in a private room are permitted to enter the private room in the enterprise social network.

14. The system of claim 9, wherein a conversation having a hash tag automatically drops into a room in the enterprise social network when a topic discussed in the room corresponds to the hash tag.

15. The system of claim 9, wherein the topic-based discussion space is a persistent and traceable archive of conversations.

16. A system to generate user skill profiles through an enterprise social network, the system comprising:
a topic-based discussion space in the enterprise social network having linked hash tags and people tags;
a topic authority score assigned to users based on interaction in the enterprise social network; and
a sorting engine configured to find a user in the topic-based discussion space matching a desired skill profile based on the topic authority score of the user.

17. The system of claim 16, wherein the topic authority score is assigned based at least in part on frequency of user interaction on a particular topic.

18. The system of claim 16, wherein the topic authority score is assigned to users based at least in part on input of other users.

19. The system of claim 16, wherein the people tags are membership indications for the topic-based discussion space.

20. The system of claim 16, wherein user participation in the topic-based discussion space is restricted.
